(19) United States
(12) Patent Application Publication
(10) Pub. No.: US 2004/0020056 A1
(43) Pub. Date: Feb. 5, 2004

(54) Combined saw blade and ruler

(76) Inventors: Joseph McFadden, Sonoma, CA (US); Robert McFadden, Pittsburgh, PA (US)

Correspondence Address: Joseph McFadden, 18950 Sweet William Court, Sonoma, CA, 95476, US

(21) Appl. No.: 10/211,711

(22) Filed: Aug. 2, 2002

(51) Int. Cl. B26B 1/00; B25F 3/00; B26B 3/00; B26D 7/06; B26B 11/00; B25F 1/00; B27B 5/29; B27B 19/09; B27B 23/00; B27B 33/20; B23D 45/00

(52) U.S. Cl. 30/123; 83/123; 30/166.3; 7/163; 7/164

(57) ABSTRACT

A combined saw blade and measuring device, or ruler. The saw blade includes a measuring device, or ruler, manufactured as an integrated component of the blade. In this case the ruler is marked, or etched, on the saw blade such that the blade acts as a ruler and straight edge. The ruler is marked on the horizontal edge opposite the saw teeth and runs the length of the saw blade. In this manner there is no need for adjunct attachments to the blade that act as measuring device or the use of a separate measuring device, or ruler, for the purpose of measuring the length of material to be cut. This design eliminates the need for a separate measuring device and therefore simplifies the process of measuring and cutting lengths of material.

### FIELD OF INVENTION

This invention relates to the process of measuring and cutting lengths of any types of materials including wood, metal, plastics, etc. More specifically, it relates to the integration of two devices for the purpose of simplifying the process of cutting lengths of materials.

### BACKGROUND OF THE INVENTION

The combined saw blade and ruler described here is specific to a hand saw apparatus. The device is used in the process of measuring and cutting lengths of any types of materials including wood, metal, plastics, etc.

In the typical process of cutting materials with a hand saw, the user performs several functions and uses multiple separate and discrete tools. First, the length of material and location of the saw cut is measured with a separate and discrete measuring device, such as a ruler or tape measure. Second, the location of the saw cut is marked using a separate and discrete marking device, such as a pencil. Third, a straight line is drawn at an angle to the edge of the material to be cut. This line is used as a guide for the saw cut. A separate and discrete straight edge tool, such as a T-square, is used to draw this line. Fourth, the hand saw is used to make the saw cut.

Other devices have been developed to simplify, or eliminate steps in, the process of cutting lengths of material. No such device was uncovered in the research that combines or integrates the function of a measuring device, or ruler, with the saw blade of a hand saw.

### CROSS-REFERENCE TO RELATED APPLICATIONS

Five categories of devices are cited that either combine rulers with other devices or integrate features other than a ruler into a saw blade. Explanations are provided for how they differ from the invention cited in this patent application.

Category 1. Chain saws with various adaptations of a ruler for measuring the length of log to be cut. Such prior art concepts are found in the following patent(s):

| | | |
|---|---|---|
| 292184 | January 1884 | Thompson |
| 806515 | December 1905 | Baumgartner |
| 2576869 | November 1951 | Woltmath |
| 2765007 | October 1956 | Hoffman |
| 3276490 | October 1966 | Johansson |
| 3364580 | January 1968 | Lucia |
| 3531870 | October 1970 | Romancky |
| 4185382 | January 1980 | Rawlinson, Jr |
| 4233739 | November 1980 | Hinrichs |
| 4275504 | January 1981 | Chontos |
| 4299034 | November 1981 | DeBetta |
| 4341018 | July 1982 | Nelson et. al. |
| 4377910 | March 1983 | Landry, Jr |
| 4388762 | June 1983 | Debell, Jr et. al. |
| 4446627 | May 1984 | Persson |
| 4545122 | October 1985 | Durfee, Jr |
| 4561186 | December 1985 | Keefe |

Unlike the design of the combined saw blade and ruler described as the subject of this patent application, the above devices are specific to the function and needs of cutting lengths of material with a chain saw. More specific to the design differences, these patents describe a device that extends out from the saw blade at a 90-degree perpendicular angle. These chain saws do not provide for a measuring device, or ruler, integrated into the saw blade and running the length of the saw blade.

Category 2. A measuring device or ruler combined with other carpentry tools used in the process of measuring and possibly cutting lengths of materials but which do not combine with a saw blade. Such prior art concepts are found in the following patent(s):

| | | |
|---|---|---|
| 5379670 | January 1995 | Ferry |
| 4404753 | September 1983 | Klok |
| Des. 432928 | October 2000 | Garrett |
| Des. 333991 | March 1993 | Lee |
| 5966820 | October 1999 | Cornacchio et. Al. |
| 4056030 | November 1977 | Hahn |

Unlike the design of the combination saw blade and ruler described as the subject of this patent application, the above devices combine a ruler with a device other than a saw blade. They may simplify the measuring of a length of material but do not, however, provide for the cutting of the length of material.

Category 3. A device with the primary function of punching holes in paper and which also combines a ruler for the purpose of accurately positioning the location of the holes. Such prior art concepts are found in the following patent(s):

| | | |
|---|---|---|
| 5340299 | August 1994 | Schwartzman |

Unlike the design of the combination saw blade and ruler described as the subject of this patent application, the above device is not designed for measuring and cutting lengths of materials. And the ruler is combined not with a saw blade but with a punch device.

Category 4. The device combines a multitude of tools including a saw blade.

| | | |
|---|---|---|
| 4741059 | May 1988 | Lee et. al. |

Unlike the design of the combination saw blade and ruler described as the subject of this patent application, the above device does not include a ruler for the purpose of measuring lengths of material to be cut.

Category 5. These devices are designed with features integrated into the saw blade and which perform specific functions to the benefit of the operation of the blade.

| | | |
|---|---|---|
| 5704828 | January 1998 | Young et. al. |
| Des. 383368 | September 1997 | Achterberg et. al. |

Unlike the design of the combination saw blade and ruler described as the subject of this patent application, the above devices do not include a ruler for the purpose of measuring lengths of material to be cut.

### BRIEF SUMMARY OF THE INVENTION

A combined saw blade and measuring device, or ruler. The invention combines the form and utility of two tools used in the process of measuring, and cutting lengths of material—a saw and a ruler. The primary tool is a handsaw with a saw toothed metal blade and a handle securely attached for the purpose of gripping and guiding the metal saw toothed blade through the sawing motion. Additionally, the invention combines a conventional ruler of inches or metric measures etched or marked into the top, leading edge of the horizontal metal saw blade. This ruler is used to accurately measure out the desired length of material for the purpose of determining where along the length of material one should place a saw cut. Previous to this device, the process of cutting lengths of material required multiple, separate tools for measuring the desired length of material, marking the location of a saw cut, and cutting or sawing the material. By combining a measuring device with the saw blade, the process of cutting materials is simplified by the elimination of physically handling two tools (the saw and the ruler) vs the one combined tool.

### BRIEF DESCRIPTION OF THE SEVERAL VIEWS OF THE DRAWING

FIG. 1 shows the combined design of a handsaw, consisting of a saw-toothed metal blade of indeterminate length attached securely to a handle used as a grip for guiding the saw-toothed blade through the sawing process or motion, and a ruler of inches or metric measures. Surface A of FIG. 1 indicates the inclusion of the ruler on the leading edge of the saw blade opposite the saw teeth. On one side of the saw blade the ruler numbering scheme begins with 1 (inch or metric) at the outer the tip of the saw blade rising in scale along the edge of the saw blade towards the handle of the saw blade. On the opposite side of the saw blade, the ruler numbering scheme begins with 1 (inch or metric) at the handle of the saw blade rising in scale along the edge of the saw blade towards the outer tip of the saw blade.

### DETAILED DESCRIPTION OF THE INVENTION

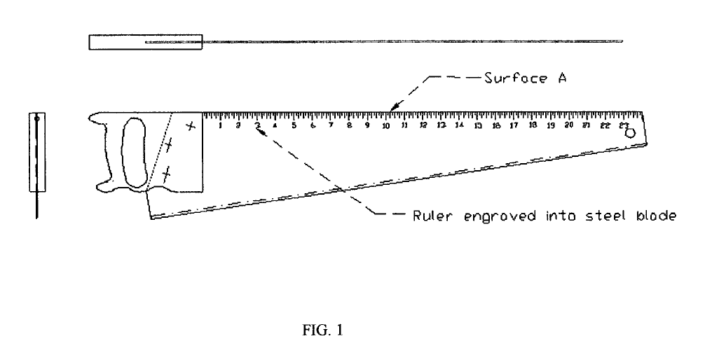

The invention is a combined saw blade and measuring device, or ruler. The invention is distinguished from other saw blades in that a ruler, or measuring device, is manufactured, engraved or etched, into the metal blade of the saw. Refer to FIG. 1, Surface A. The ruler runs the length of the saw blade and along the top leading edge of the saw blade opposite the saw teeth. The units of measure are in inches or metric units. On one side of the saw blade the ruler numbering scheme begins with 1 (inch or metric) at the outer the tip of the saw blade rising in scale along the edge of the saw blade towards the handle of the saw blade. On the opposite side of the saw blade, the ruler numbering scheme begins with 1 (inch or metric) at the handle of the saw blade rising in scale along the edge of the saw blade towards the outer tip of the saw blade.

The invention is used to both measure and cut lengths of materials. The one device is used to first measure out and locate the point on a length of material where a saw cut is desired. The upper leading edge of the saw blade is then used as a straightedge to draw a line perpendicular to the length of material at the point of the saw cut. This line drawn on the material acts as a visual guide for the saw cut. Lastly, the same device is used to make the saw cut.

By combining the two devices (the measuring device and the saw blade) the process of making saw cuts is simplified. Although the number of tools required to make a cut is not reduced, by combining the saw blade and the ruler, there are fewer separate and discrete tools in the process that must be handled to accomplish the task.

1. We claim as our invention the combination of a saw blade and a ruler with units of measure used for the purpose of measuring and cutting lengths of material.
